(19) United States
(12) Patent Application Publication
(10) Pub. No.: US 2022/0279267 A1
(43) Pub. Date: Sep. 1, 2022

(54) Optical Measurement System Integrated into a Hearing Device

(71) Applicant: HI LLC, Los Angeles, CA (US)

(72) Inventors: Bryan Johnson, Culver City, CA (US); Ryan Field, Culver City, CA (US)

(21) Appl. No.: 17/665,851

(22) Filed: Feb. 7, 2022

Related U.S. Application Data
(60) Provisional application No. 63/191,822, filed on May 21, 2021.
(60) Provisional application No. 63/154,127, filed on Feb. 26, 2021.

(51) Int. Cl. H04R 1/10; G01J 1/44

(52) U.S. Cl. CPC H04R 1/1041; H04R 1/1008; H04R 1/1016; G01J 1/44; H04R 2420/07; G01J 2001/4466

(57) ABSTRACT

An illustrative system includes a hearing device configured to be worn by a user, the hearing device comprising an output transducer configured to present audio content to the user and an optical measurement system configured to output optical measurement data representative of one or more optical measurements performed with respect to the user.

### RELATED APPLICATIONS

The present application claims priority under 35 U.S.C. § 119(e) to U.S. Provisional Patent Application No. 63/191,822, filed on May 21, 2021, and to U.S. Provisional Patent Application No. 63/154,127, filed Feb. 26, 2021, each of which are incorporated herein by reference in their respective entireties.

### BACKGROUND INFORMATION

With the wide availability of portable electronics, streaming services, and Internet connections, people are consuming more audio content (e.g., music, podcasts, news, etc.) on a daily basis than ever before. This audio content can affect a person's mental state, ability to think clearly and/or perform physical tasks, exercise impulse control, interact with others, and/or otherwise function mentally and/or physically. Accordingly, it would be desirable to be able to determine this effect in substantially real time as audio content is being consumed by a user and adjust one or more attributes of the audio content in a manner that helps the user achieve a desired mental state and/or optimizes the user's ability to function mentally and/or physically.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary hearing device.

FIG. 2 shows an exemplary system that includes a hearing device and a processor.

FIGS. 3A-3B show exemplary implementations of the system of FIG. 2.

FIG. 4 shows a configuration in which a processor may be configured to adjust one or more attributes of audio content by controlling an operation of a hearing device.

FIG. 5 shows a configuration in which a processor may be configured to adjust one or more attributes of audio content by controlling an operation of an audio player device communicatively coupled to a hearing device.

FIG. 6 shows a headphone implementation of a hearing device.

FIG. 7 shows an earpiece implementation of a hearing device.

FIGS. 8-10 show exemplary optical measurement systems.

FIG. 11 shows an exemplary computing system,

FIG. 12 illustrates an exemplary computing device,

FIG. 13 illustrates an exemplary method.

### DETAILED DESCRIPTION

An illustrative hearing device configured to be worn by a user may include an output transducer configured to present audio content to the user and an optical measurement system configured to output optical measurement data representative of one or more optical measurements performed with respect to the user.

In some examples, a processor (e.g., a processor included in the hearing device and/or in a device separate from the hearing device) may be configured to perform an operation based on the audio content and the optical measurement data. For example, the processor may adjust one or more attributes associated with the audio content based on the optical measurement data (e.g., by controlling an operation of the hearing device and/or an audio player device communicatively coupled to the hearing device based on the optical measurement data).

The devices, systems, and methods described herein may provide a number of advantages and benefits over conventional hearing devices. For example, by including an optical measurement system in a hearing device, brain activity data and/or other types of optical measurement data may be acquired while the user is listening to audio content by way of the hearing device. Based on the optical measurement data, a processor may determine, e.g., in real time, an effect of the audio content on the user and adjust one or more attributes of the audio content accordingly. For example, as described herein, the audio content may be adjusted to help the user achieve a desired mental state and/or more effectively perform one or more mental and/or physical tasks. These and other advantages and benefits of the devices, systems, and methods described herein are described more fully herein.

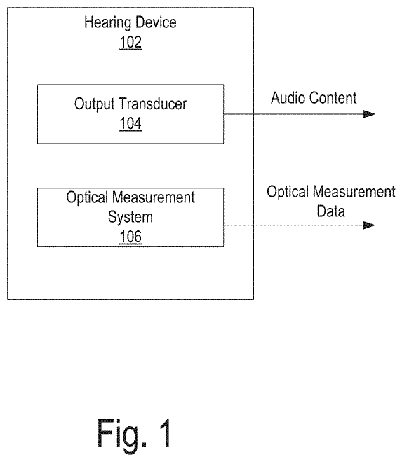

FIG. 1 illustrates an exemplary hearing device 102 in accordance with the principles described herein. In some examples, hearing device 102 is wearable by a user. For example, hearing device 102 may be worn on a user's head, on a user's ear(s), at least partially in a user's ear (e.g., at an entrance to an ear canal of the user), etc.

Hearing device 102 may be implemented by any suitable device configured to present audio content to a user. For example, hearing device 102 may be implemented by headphones, one or more earpieces or earbuds, a hearable (e.g., smart headphones or smart earbuds), a hearing aid, a headphone style band, etc. Hearing device 102 may be associated with (i.e., provide audio content to) a single ear or bilateral in both ears.

In some examples, hearing device 102 is configured to be communicatively coupled (e.g., by way of a wireless and/or wired connection) to an audio player device (not shown), The audio player device may be configured to provide the audio content to hearing device 102 for presentation to the user and may be implemented by any computing device (e.g., a mobile electronic device, etc.) as may serve a particular implementation. Additionally or alternatively, hearing device 102 may include a processor configured to generate the audio content that is presented to the user.

As shown, hearing device 102 includes an output transducer 104 configured to output audio content for presentation to a user. Output transducer 104 may be implemented by any suitable audio output device, such as speaker (also referred to as a loudspeaker or receiver).

Hearing device 102 further includes an optical measurement system 106. Optical measurement system 106 may be included in hearing device 102 in any suitable manner. Exemplary configurations in which optical measurement system 106 is included in (also referred to as “integrated into”) hearing device 102 are described herein.

Optical measurement system 106 is configured to output optical measurement data, which may be generated using any suitable time domain-based optical measurement technique, such as time-correlated single-photon counting (TCSPC), time domain near infrared spectroscopy (TD-NIRS), time domain diffusive correlation spectroscopy (TD-DCS), and/or time domain digital optical tomography (TD-DOT). In some examples, the optical measurement data may include brain activity data representative of brain activity of the user. Additionally or alternatively, the optical measurement data may be representative of one or more non-invasive measurements of blood oxygen saturation (SaO2) through Time-Resolved Pulse Oximetry (TR-SpO2). Exemplary implementations of optical measurement system 106 are described herein.

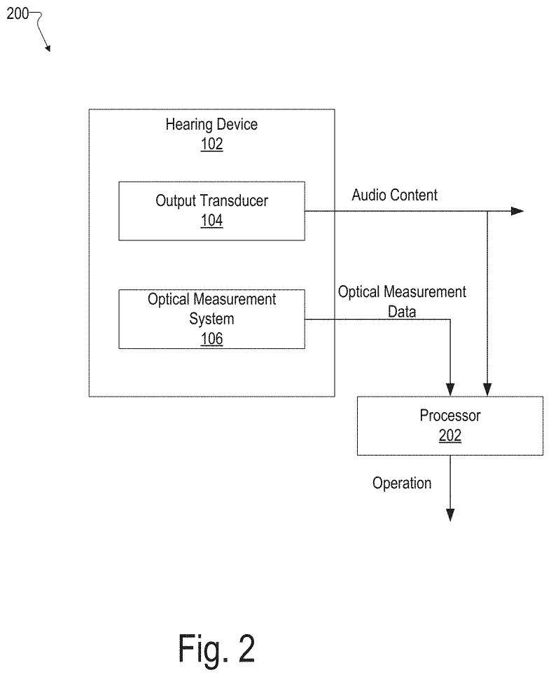

FIG. 2 shows an exemplary system 200 that includes hearing device 102 and a processor 202. Processor 202 is configured to receive the audio content output by output transducer 104 (or data representative of audio content) and optical measurement data output by optical measurement system 106 as inputs. Processor 202 may be further configured to perform an operation based on the audio content and the optical measurement data, Exemplary operations that may be performed by processor 202 are described herein.

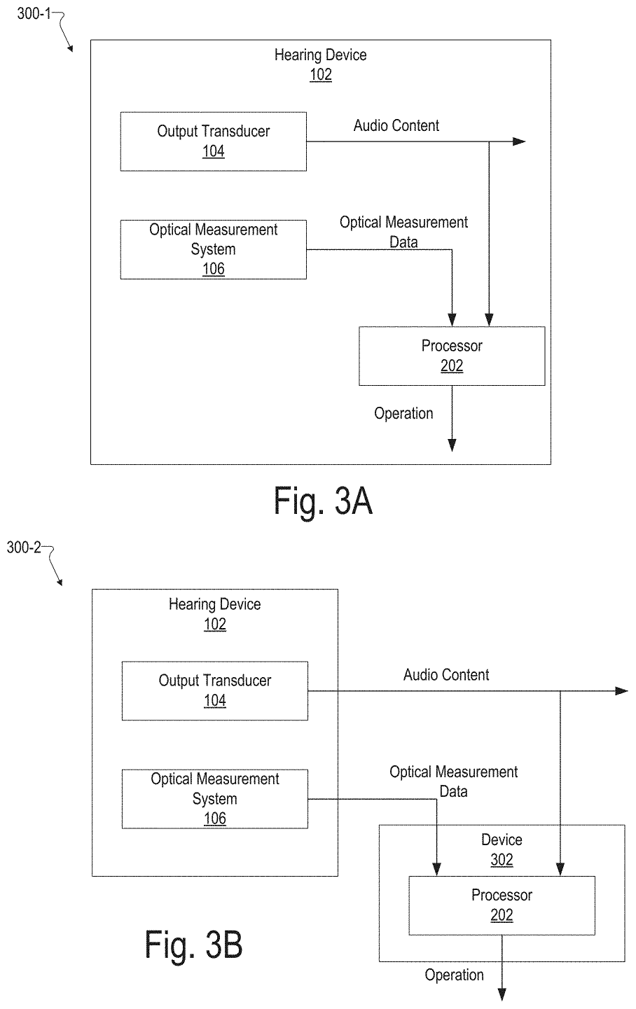

Processor 202 may be implemented by any suitable processing or computing device. Moreover, processor 202 may be included in any suitable device. To illustrate, FIG. 3A shows an implementation 300-1 in which processor 202 is included in hearing device 102. FIG. 3B shows an alternative implementation 300-2 in which processor 202 is included in a device 302 separate from hearing device 102. Device 302 may be implemented by any suitable housing and/or computing device as may serve a particular implementation. For example, device 302 may be implemented by a mobile device (e.g., a mobile phone) used by the user and configured to communicatively couple to hearing device 102. In some examples, device 302 is wearable by the user.

Exemplary operations that may be performed by processor 202 based on audio content output by output transducer 104 and optical measurement data output by optical measurement system 106 will now be described. The operations described herein are merely illustrative of the many different operations that may be performed by processor 202 in accordance with the principles described herein.

In some examples, processor 202 may adjust one or more attributes associated with the audio content based on the optical measurement data. This may be performed in any suitable manner. For example, processor 202 may transmit (e.g., wirelessly or by way of a wired connection) one or more commands to hearing device 102 and/or an audio player device communicatively coupled to hearing device 102.

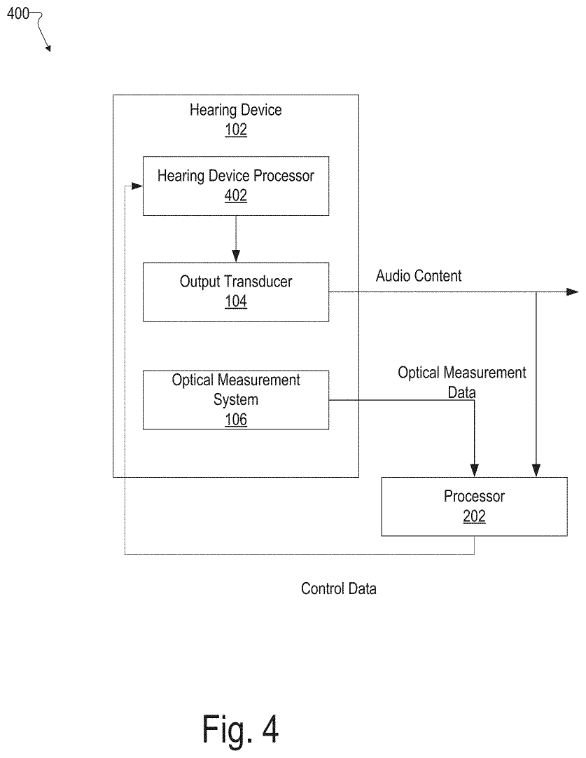

To illustrate, FIG. 4 shows a configuration 400 in which processor 202 may be configured to adjust one or more attributes of the audio content by controlling an operation of hearing device 102. As shown, in configuration 400, hearing device 102 may include a processor 402 (referred to herein as a hearing device processor 402). Hearing device processor 402 may be configured to provide hearing device 102 with processing functionality, such as processing incoming sound detected by a microphone (not shown) included in hearing device 102 and generating the audio content based on the detected sound, receiving streaming audio by way of a network connection, etc.

As shown, processor 202 is configured to output control data based on the optical measurement data and the audio content. The control data may be transmitted to hearing device processor 402 and may include one or more commands configured to direct hearing device processor 402 to perform one or more operations. For example, the control data may direct hearing device processor 402 to adjust a volume level of the audio content being presented by output transducer 104, present a particular audio content instance (e.g., a particular song having a desired attribute) by way of output transducer 104 to the user, adjust a spectral and/or temporal characteristic of the audio content, abstain from presenting the audio content for a period of time, and/or perform any other suitable operation with respect to the audio content as may serve a particular implementation.

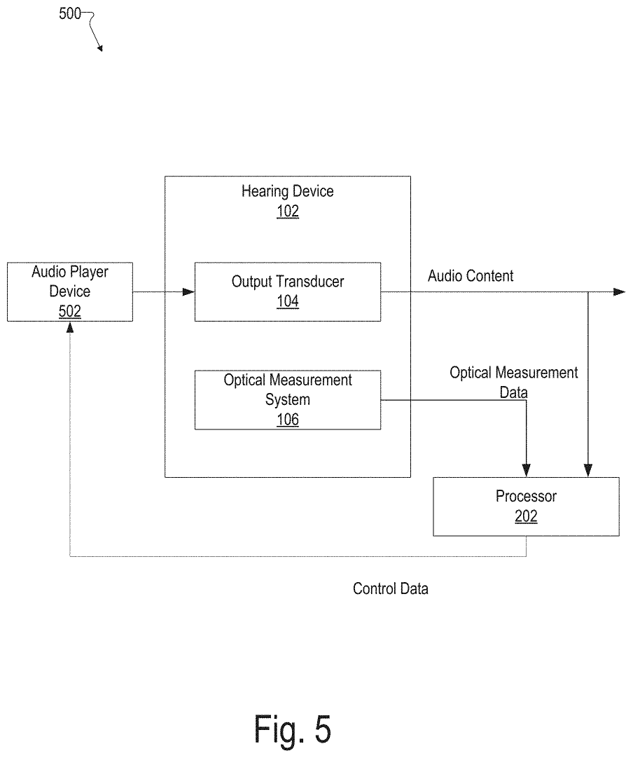

FIG. 5 shows a configuration 500 in which processor 202 may be configured to adjust one or more attributes of the audio content by controlling an operation of an audio player device 502 communicatively coupled to hearing device 102. Audio player device 502 may be implemented by any suitable computing device configured to provide the audio content to hearing device 102 (e.g., to output transducer 104) for presentation to the user. For example, audio player device 502 may be implemented by a mobile device (e.g., a mobile phone, a tablet computer, etc.), a gaming device, a television, a portable media player, etc.

As shown, processor 202 is configured to output control data based on the optical measurement data and the audio content. The control data may be transmitted to audio player device 502 and may include one or more commands configured to direct audio player device 502 to perform one or more operations. For example, the control data may direct audio player device 502 to perform any of the operations described in connection with FIG. 4.

In either configuration 400 or configuration 500, processor 202 may be configured to adjust one or more attributes associated with the audio content based on the optical measurement data in any suitable manner. For example, processor 202 may determine, based on the optical measurement data, an effect of the audio content on the user, Processor 202 may adjust the one or more attributes of the audio content based on the determined effect.

By way of example, while the user is listening to a particular song, the optical measurement data output by optical measurement system 106 may indicate that the song is making the user feel a certain way (e.g., anxious), lessening the users ability to exercise impulse control, and/or lessening the user's ability to think clearly about a task at hand. Based on this, processor 202 may adjust one or more attributes of the song itself (e.g., a volume level of the song, a pitch of the song, a playback speed of the song, etc.). Additionally or alternatively, processor 202 may cause a different song (e.g., a song with attributes known to put the user in a better mood and/or perform better mentally and/or physically) to be presented to the user in place of the song, cause hearing device 102 to stop presenting the song to the user, etc.

As another example, processor 202 may determine, based on the optical measurement data, a current mental state of the user. Processor 202 may be further configured to obtain data representative of a desired mental state of the user (e.g., by way of user input provided by the user and/or based on an activity being performed by the user). Based on the current mental state and the desired mental state, processor 202 may adjust one or more attributes of the audio content to change the current mental state of the user to the desired mental state of the user.

As used herein, mental states may include joy, excitement, relaxation, surprise, fear, stress, anxiety, sadness, anger, disgust, contempt, contentment, calmness, approval, focus, attention, creativity, cognitive assessment, positive or negative reflections/attitude on experiences or the use of objects, etc. Further details on the methods and systems related to a predicted brain state, behavior, preferences, or attitude of the user, and the creation, training, and use of neuromes can be found in U.S. patent application Ser. No. 17/188,298, filed Mar. 1, 2021, issued as U.S. Pat. No. 11,132,625. Exemplary measurement systems and methods using biofeedback for awareness and modulation of mental state are described in more detail in U.S. patent application Ser. No. 16/364,338, filed Mar. 26, 2019, issued as U.S. Pat. No. 11,006,876. Exemplary measurement systems and methods used for detecting and modulating the mental state of a user using entertainment selections, e.g., music, film/video, are described in more detail in U.S. patent application Ser. No. 16/835,972, filed Mar. 31, 2020, issued as U.S. Pat. No. 11,006,878. Exemplary measurement systems and methods used for detecting and modulating the mental state of a user using product formulation from, e.g., beverages, food, selective food/drink ingredients, fragrances, and assessment based on product-elicited brain state measurements are described in more detail in U.S. patent application Ser. No. 16/853,614, filed Apr. 20, 2020, issued as U.S. Pat. No. 11,172,869. Exemplary measurement systems and methods used for detecting and modulating the mental state of a user through awareness of priming effects are described in more detail in U.S. patent application Ser. No. 16/885,596, filed May 28, 2020, published as US2020/0390358A1. Exemplary measurement systems and methods used for wellness therapy, such as pain management regime, are described more fully in U.S. Provisional Application No. 63/188,783, filed May 14, 2021. These applications and corresponding U.S. patents and publications are incorporated herein by reference in their entirety.

In some examples, processor 202 may present, by way of a graphical user interface, content associated with the optical measurement data. For example, processor 202 may present one or more graphs, recommendations, information, etc. based on the optical measurement data and the audio content presented to the user.

Optical measurement system 106 may be included in hearing device 102 in any suitable manner. For example, optical measurement system 106 may be included in a housing of hearing device 102 and/or one or more components of hearing device 102.

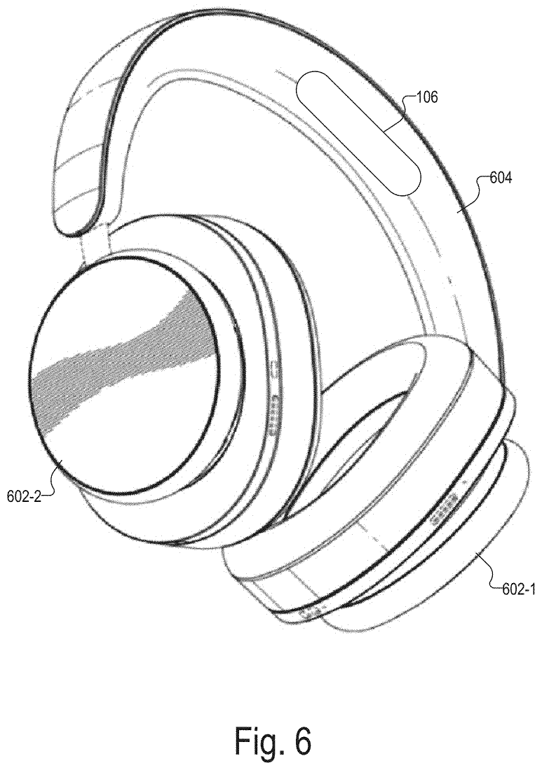

To illustrate, FIG. 6 shows a headphone implementation of hearing device 102. In this implementation, hearing device 102 includes a left headphone 602-1 configured to be worn at a left ear of the user, a right headphone 602-2 configured to be worn at a right ear of the user, and a headband 604 configured to be worn on a head of the user and to connect the left headphone 602-1 to the right headphone 602-2, In this implementation, optical measurement system 106 is included in headband 604 so that it can be in contact with the head of the user while hearing device 102 is being worn by the user. Optical measurement system 106 may additionally or alternatively be included in headphones 602-1 and/or 602-2 as may serve a particular implementation.

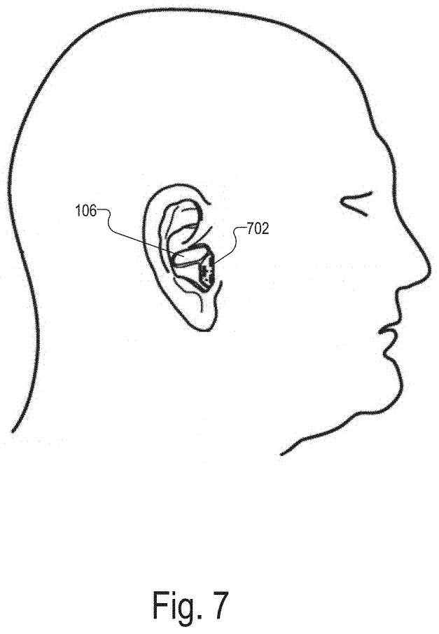

As another example, FIG. 7 shows an earpiece implementation of hearing device 102. In this implementation, hearing device 102 includes or is implemented by an earpiece 702 configure to be worn by a user at an entrance to an ear canal of the user. As shown, optical measurement system 106 may be included in the earpiece.

Various implementations of optical measurement system 106 will now be described.

In some examples, optical measurement system 106 may be implemented by any suitable wearable system configured to perform optical-based brain data acquisition operations, such as any of the wearable optical measurement systems described in U.S. patent application Ser. No. 17/176,315, filed Feb. 16, 2021 and published as US2021/0259638A1; U.S. patent application Ser. No. 17/176,309, filed Feb. 16, 2021 and published as US2021/0259614A1; U.S. patent application Ser. No. 17/176,460, filed Feb. 16, 2021 and issued as U.S. Pat. No. 11,096,620; U.S. patent application Ser. No. 17/176,470, filed Feb. 16, 2021 and published as US2021/0259619A1; U.S. patent application Ser. No. 17/176,487, filed Feb. 16, 2021 and published as US2021/0259632A1; U.S. patent application Ser. No. 17/176,539, filed Feb. 16, 2021 and published as US2021/0259620A1: U.S. patent application Ser. No. 17/176,560, filed Feb. 16, 2021 and published as US2021/0259597A1; U.S. patent application Ser. No. 17/176,466, filed Feb. 16, 2021 and published as US2021/0263320A1; Han Y. Ban, et al., “Kernel Flow: A High Channel Count Scalable TD-fNIRS System,” SPIE Photonics West Conference (Mar. 6, 2021); and Han Y. Ban, et al., “Kernel Flow: a high channel count scalable time-domain functional near-infrared spectroscopy system,” Journal of Biomedical Optics (Jan. 18, 2022), which applications and publications are incorporated herein by reference in their entirety.

Additionally or alternatively, optical measurement system 106 may be configured to non-invasively measure blood oxygen saturation (SaO2) (e.g., at the ear) through Time-Resolved Pulse Oximetry (TR-SpO2), such as one or more of the devices described in more detail in U.S. Provisional Patent Application No. 63/134,479, filed Jan. 6, 2021, U.S. Provisional Patent Application No. 63/154,116, filed Feb. 26, 2021, U.S. Provisional Patent Application No. 63/160,995, filed Mar. 15, 2021, and U.S. Provisional Patent Application No. 63/179,080, filed Apr. 23, 2021, which applications are incorporated herein by reference. Using time-resolved techniques, information that allows for determining the absolute coefficients of absorption (μₐ) and reduced scattering (μₛ′) can be determined. From these absolute tissue properties, tissue oxygenation may be determined through the Beer-Lambert Law.

Additionally or alternatively, optical measurement system 106 may be configured to perform both optical-based brain data acquisition operations and electrical-based brain data acquisition operations, such as any of the wearable multimodal measurement systems described in U.S. Patent Application Publication Nos. 2021/0259638 and 2021/0259614, which publications are incorporated herein by reference in their respective entireties.

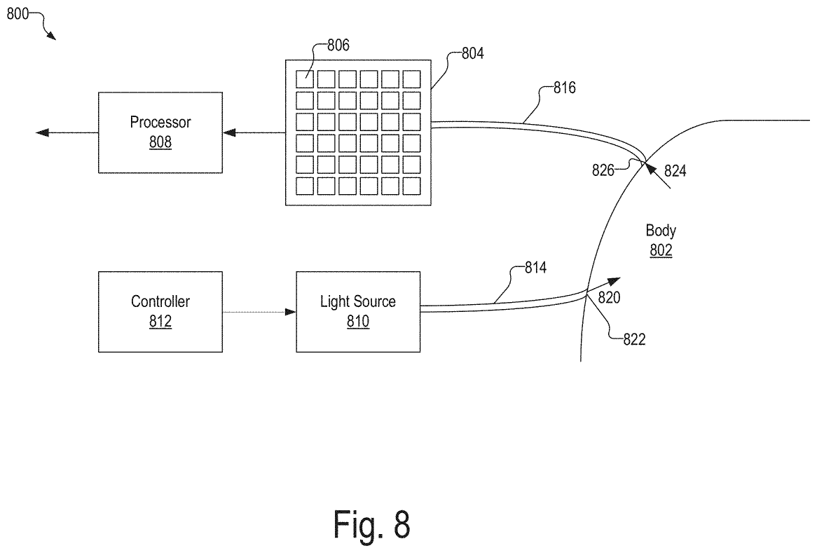

FIG. 8 shows an optical measurement system 800 that may implement optical measurement system 106 and that may be configured to perform an optical measurement operation with respect to a body 802 (e.g., the brain). Optical measurement system 800 may, in some examples, be portable and/or wearable by a user.

In some examples, optical measurement operations performed by optical measurement system 800 are associated with a time domain-based optical measurement technique. Example time domain-based optical measurement techniques include, but are not limited to, TCSPC, TD-NIRS, TD-DCS, and TD-DOT.

Optical measurement system 800 (e.g., an optical measurement system that is implemented by a wearable device or other configuration, and that employs a time domain-based (e.g., TD-NIRS) measurement technique) may detect blood oxygenation levels and/or blood volume levels by measuring the change in shape of laser pulses after they have passed through target tissue, e.g., brain, muscle, finger, etc. As used herein, a shape of laser pulses refers to a temporal shape, as represented for example by a histogram generated by a time-to-digital converter (TDC) coupled to an output of a photodetector, as will be described more fully below.

As shown, optical measurement system 800 includes a detector 804 that includes a plurality of individual photodetectors (e.g., photodetector 806), a processor 808 coupled to detector 804, a light source 810, a controller 812, and optical conduits 814 and 816 (e.g., light pipes). However, one or more of these components may not, in certain embodiments, be considered to be a part of optical measurement system 800. For example, in implementations where optical measurement system 800 is wearable by a user, processor 808 and/or controller 812 may in some embodiments be separate from optical measurement system 800 and not configured to be worn by the user.

Detector 804 may include any number of photodetectors 806 as may serve a particular implementation, such as 8ⁿ photodetectors (e.g., 856, 512, . . . , 86384, etc.), where n is an integer greater than or equal to one (e.g., 4, 5, 8, 80, 81, 84, eta). Photodetectors 806 may be arranged in any suitable manner.

Photodetectors 806 may each be implemented by any suitable circuit configured to detect individual photons of light incident upon photodetectors 806. For example, each photodetector 806 may be implemented by a single photon avalanche diode (SPAD) circuit and/or other circuitry as may serve a particular implementation. The SPAD circuit may be gated in any suitable manner or be configured to operate in a free running mode with passive quenching. For example, photodetectors 806 may be configured to operate in a free-running mode such that photodetectors 806 are not actively armed and disarmed (e.g., at the end of each predetermined gated time window). In contrast, while operating in the free-running mode, photodetectors 806 may be configured to reset within a configurable time period after an occurrence of a photon detection event (i.e., after photodetector 806 detects a photon) and immediately begin detecting new photons. However, only photons detected within a desired time window (e.g., during each gated time window) may be included in the histogram that represents a light pulse response of the target (e.g., a temporal point spread function (TPSF)). The terms histogram and TPSF are used interchangeably herein to refer to a light pulse response of a target.

Processor 808 may be implemented by one or more physical processing (e.g., computing) devices. In some examples, processor 808 may execute instructions (e.g., software) configured to perform one or more of the operations described herein.

Light source 810 may be implemented by any suitable component configured to generate and emit light. For example, light source 810 may be implemented by one or more laser diodes, distributed feedback (DFB) lasers, super luminescent diodes (SLDs), light emitting diodes (LEDs), diode-pumped solid-state (DPSS) lasers, super luminescent light emitting diodes (sLEDs), vertical-cavity surface-emitting lasers (VCSELs), titanium sapphire lasers, micro light emitting diodes (mLEDs), and/or any other suitable laser or light source. In some examples, the light emitted by light source 810 is high coherence light (e.g., light that has a coherence length of at least 5 centimeters) at a predetermined center wavelength.

Light source 810 is controlled by controller 812, which may be implemented by any suitable computing device (e.g., processor 808), integrated circuit, and/or combination of hardware and/or software as may serve a particular implementation. In some examples, controller 812 is configured to control light source 810 by turning light source 810 on and off and/or setting an intensity of light generated by light source 810. Controller 812 may be manually operated by a user, or may be programmed to control light source 810 automatically.

Light emitted by light source 810 may travel via an optical conduit 814 (e.g., a light pipe, a single-mode optical fiber, and/or or a multi-mode optical fiber) to body 802 of a subject. Body 802 may include any suitable turbid medium. For example, in some implementations, body 802 is a brain or any other body part of a human or other animal. Alternatively, body 802 may be a non-living object. For illustrative purposes, it will be assumed in the examples provided herein that body 802 is a human brain.

As indicated by arrow 820, the light emitted by light source 810 enters body 802 at a first location 822 on body 802. Accordingly, a distal end of optical conduit 814 may be positioned at (e.g., right above, in physical contact with, or physically attached to) first location 822 (e.g., to a scalp of the subject), In some examples, the light may emerge from optical conduit 814 and spread out to a certain spot size on body 802 to fall under a predetermined safety limit. At least a portion of the light indicated by arrow 820 may be scattered within body 802.

As used herein, “distal” means nearer, along the optical path of the light emitted by light source 810 or the light received by detector 804, to the target (e.g., within body 802) than to light source 810 or detector 804. Thus, the distal end of optical conduit 814 is nearer to body 802 than to light source 810, and the distal end of optical conduit 816 is nearer to body 802 than to detector 804. Additionally, as used herein, “proximal” means nearer, along the optical path of the light emitted by light source 810 or the light received by detector 804, to light source 810 or detector 804 than to body 802. Thus, the proximal end of optical conduit 814 is nearer to light source 810 than to body 802, and the proximal end of optical conduit 816 is nearer to detector 804 than to body 802.

As shown, the distal end of optical conduit 816 (e.g., a light pipe, a light guide, a waveguide, a single-mode optical fiber, and/or a multi-mode optical fiber) is positioned at (e.g., right above, in physical contact with, or physically attached to) output location 826 on body 802. In this manner, optical conduit 816 may collect at least a portion of the scattered light (indicated as light 824) as it exits body 802 at location 826 and carry light 824 to detector 804. Light 824 may pass through one or more lenses and/or other optical elements (not shown) that direct light 824 onto each of the photodetectors 806 included in detector 804. In cases where optical conduit 816 is implemented by a light guide, the light guide may be spring loaded and/or have a cantilever mechanism to allow for conformably pressing the light guide firmly against body 802.

Photodetectors 806 may be connected in parallel in detector 804. An output of each of photodetectors 806 may be accumulated to generate an accumulated output of detector 804. Processor 808 may receive the accumulated output and determine, based on the accumulated output, a temporal distribution of photons detected by photodetectors 806. Processor 808 may then generate, based on the temporal distribution, a histogram representing a light pulse response of a target (e.g., brain tissue, blood flow, etc.) in body 802. Such a histogram is illustrative of the various types of brain activity measurements that may be performed by optical measurement system 800.

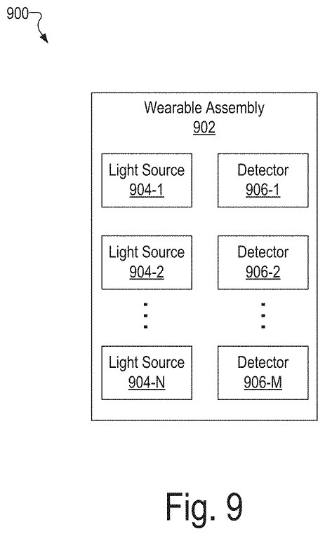

FIG. 9 shows an exemplary optical measurement system 900 in accordance with the principles described herein. Optical measurement system 900 may be an implementation of optical measurement system 800 and, as shown, includes a wearable assembly 902, which includes N light sources 904 (e.g., light sources 904-1 through 904-N) and M detectors 906 (e.g., detectors 906-1 through 906-M). Optical measurement system 900 may include any of the other components of optical measurement system 800 as may serve a particular implementation. N and M may each be any suitable value (i.e., there may be any number of light sources 904 and detectors 906 included in optical measurement system 900 as may serve a particular implementation).

Light sources 904 are each configured to emit light (e.g., a sequence of light pulses) and may be implemented by any of the light sources described herein. Detectors 906 may each be configured to detect arrival times for photons of the light emitted by one or more light sources 904 after the light is scattered by the target. For example, a detector 906 may include a photodetector configured to generate a photodetector output pulse in response to detecting a photon of the light and a time-to-digital converter (TQC) configured to record a timestamp symbol in response to an occurrence of the photodetector output pulse, the timestamp symbol representative of an arrival time for the photon (La, when the photon is detected by the photodetector).

Wearable assembly 902 may be implemented by any of the wearable devices, modular assemblies, and/or wearable units described herein. For example, wearable assembly 902 may be integrated into one or more components of hearing device 102.

Optical measurement system 900 may be modular in that one or more components of optical measurement system 900 may be removed, changed out, or otherwise modified as may serve a particular implementation. As such, optical measurement system 900 may be configured to conform to three-dimensional surface geometries, such as a user's head. Exemplary modular optical measurement systems comprising a plurality of wearable modules are described in more detail in U.S. patent application Ser. No. 17/176,460, filed Feb. 16, 2021 and issued as U.S. Pat. No. 11,096,620, U.S. patent application Ser. No. 17/176,470, filed Feb. 16, 2021 and published as US2021/0259619A1, U.S. patent application Ser. No. 17/176,487, filed Feb. 16, 2021 and published as US2021/0259632A1, U.S. patent application Ser. No. 17/176,539, filed Feb. 16, 2021 and published as US2021/0259620A1, U.S. patent application Ser. No. 17/176,560, filed Feb. 16, 2021 and published as US2021/0259597A1, and U.S. patent application Ser. No. 17/176,466, filed Feb. 16, 2021 and published as US2021/0263320A1, which applications are incorporated herein by reference in their respective entireties.

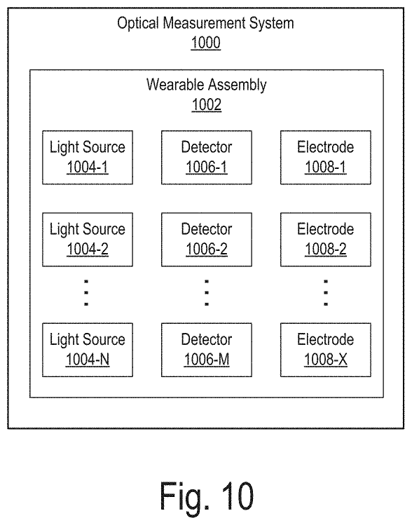

FIG. 10 shows an exemplary optical measurement system 1000 configured to perform both optical-based brain data acquisition operations and electrical-based brain data acquisition operations. Optical measurement system 1000 may at least partially implement optical measurement system 800 and, as shown, includes a wearable assembly 1002 (which is similar to wearable assembly 902), which includes N light sources 1004 (e.g., light sources 1004-1 through 1004-N, which are similar to light sources 904), M detectors 1006 (e.g., detectors 1006-1 through 1006-M, which are similar to detectors 906), and X electrodes (e.g., electrodes 1008-1 through 1008-X), Optical measurement system 1000 may include any of the other components of optical measurement system 800 as may serve a particular implementation, N, M, and X may each be any suitable value (i.e., there may be any number of light sources 1004, any number of detectors 1006, and any number of electrodes 1008 included in optical measurement system 1000 as may serve a particular implementation).

Electrodes 1008 may be configured to detect electrical activity within a target (e.g., the brain). Such electrical activity may include electroencephalogram (EEG) activity and/or any other suitable type of electrical activity as may serve a particular implementation. In some examples, electrodes 1008 are all conductively coupled to one another to create a single channel that may be used to detect electrical activity. Alternatively, at least one electrode included in electrodes 1008 is conductively isolated from a remaining number of electrodes included in electrodes 1008 to create at least two channels that may be used to detect electrical activity.

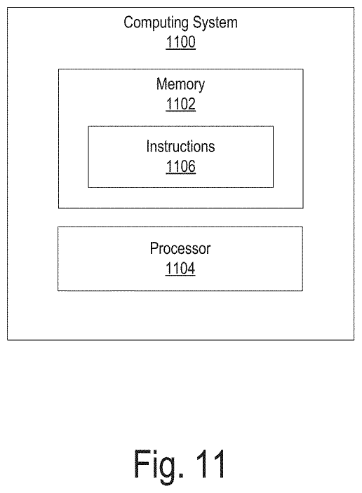

FIG. 11 shows an exemplary computing system 1100 that may implement processor 202. As shown, computing system 1100 may include memory 1102 and a processor 1104. Computing system 1100 may include additional or alternative components as may serve a particular implementation. Each component may be implemented by any suitable combination of hardware and/or software.

Memory 1102 may maintain (e.g., store) executable data used by processor 1104 to perform one or more of the operations described herein. For example, memory 1102 may store instructions 1106 that may be executed by processor 1104 to perform one or more operations based on optical measurement data output by optical measurement system 106 and audio content output by output transducer 104. Instructions 1106 may be implemented by any suitable application, program, software, code, and/or other executable data instance, Memory 1102 may also maintain any data received, generated, managed, used, and/or transmitted by processor 1104.

Processor 1104 may be configured to perform (e.g., execute instructions 1106 stored in memory 1102 to perform) various operations described herein.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g. a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

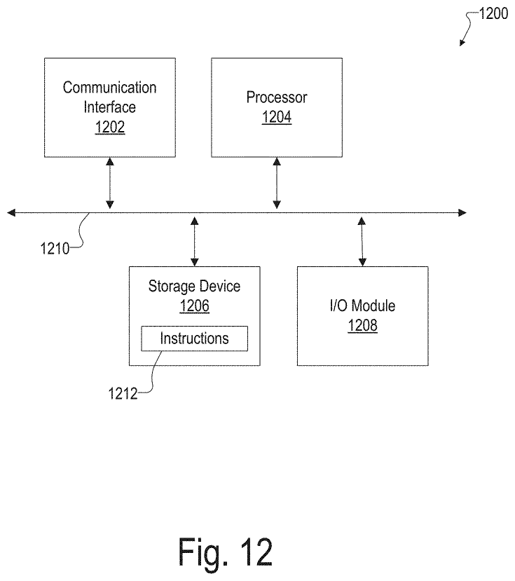

FIG. 12 illustrates an exemplary computing device 1200 that may be specifically configured to perform one or more of the processes described herein. Any of the systems, units, computing devices, and/or other components described herein may be implemented by computing device 1200.

As shown in FIG. 12, computing device 1200 may include a communication interface 1202, a processor 1204, a storage device 1206, and an input/output (“I/O”) module 1208 communicatively connected one to another via a communication infrastructure 1210. While an exemplary computing device 1200 is shown in FIG. 12, the components illustrated in FIG. 12 are not intended to be limiting. Additional or alternative components may be used in other embodiments. Components of computing device 1200 shown in FIG. 12 will now be described in additional detail.

Communication interface 1202 may be configured to communicate with one or more computing devices. Examples of communication interface 1202 include, without limitation, a wired network interface (such as a network interface card), a wireless network interface (such as a wireless network interface card), a modem, an audio/video connection, and any other suitable interface.

Processor 1204 generally represents any type or form of processing unit capable of processing data and/or interpreting, executing, and/or directing execution of one or more of the instructions, processes, and/or operations described herein. Processor 1204 may perform operations by executing computer-executable instructions 1212 (e.g., an application, software, code, and/or other executable data instance) stored in storage device 1206.

Storage device 1206 may include one or more data storage media, devices, or configurations and may employ any type, form, and combination of data storage media and/or device. For example, storage device 1206 may include, but is not limited to, any combination of the non-volatile media and/or volatile media described herein. Electronic data, including data described herein, may be temporarily and/or permanently stored in storage device 1206. For example, data representative of computer-executable instructions 1212 configured to direct processor 1204 to perform any of the operations described herein may be stored within storage device 1206. In some examples, data may be arranged in one or more databases residing within storage device 1206.

I/O module 1208 may include one or more I/O modules configured to receive user input and provide user output. I/O module 1208 may include any hardware, firmware, software, or combination thereof supportive of input and output capabilities. For example, I/O module 1208 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1208 is configured to provide graphical data to a display for presentation to a user. The graphical data may be representative of one or more graphical user interfaces and/or any other graphical content as may serve a particular implementation.

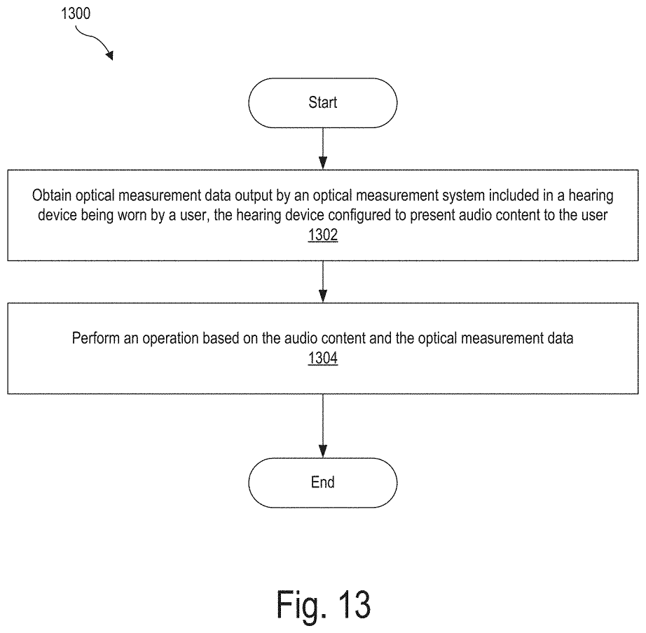

FIG. 13 illustrates an exemplary method 1300. While FIG. 13 illustrates exemplary operations according to one embodiment, other embodiments may omit, add to, reorder, and/or modify any of the operations shown in FIG. 13. One or more of the operations shown in FIG. 13 may be performed by processor 202 and/or any implementation thereof. Each of the operations illustrated in FIG. 13 may be performed in any suitable manner.

At operation 1302, a processor obtains optical measurement data output by an optical measurement system included in a hearing device being worn by a user, the hearing device configured to present audio content to the user.

At operation 1304, the processor performs an operation based on the audio content and the optical measurement data.

An illustrative system includes a hearing device configured to be worn by a user, the hearing device comprising an output transducer configured to present audio content to the user and an optical measurement system configured to output optical measurement data representative of one or more optical measurements performed with respect to the user.

Another illustrative system includes a hearing device configured to be worn by a user and present audio content to the user; an optical measurement system included in the hearing device, the optical measurement system configured to perform one or more optical measurements with respect to the user and output optical measurement data representative of the one or more optical measurements; and a processor configured to perform an operation based on the audio content and the optical measurement data.

Another illustrative system includes a memory storing instructions; and a processor communicatively coupled to the memory and configured to execute the instructions to obtain optical measurement data output by an optical measurement system included in a hearing device being worn by a user, the hearing device configured to present audio content to the user; and perform an operation based on the audio content and the optical measurement data.

An illustrative method includes obtaining, by a processor, optical measurement data output by an optical measurement system included in a hearing device being worn by a user, the hearing device configured to present audio content to the user; and performing, by the processor, an operation based on the audio content and the optical measurement data.

An illustrative non-transitory computer-readable medium stores instructions that, when executed, direct a processor of a computing device to obtain optical measurement data output by an optical measurement system included in a hearing device being worn by a user, the hearing device configured to present audio content to the user; and perform an operation based on the audio content and the optical measurement data.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A system comprising:
a hearing device configured to be worn by a user, the hearing device comprising:
an output transducer configured to present audio content to the user; and
an optical measurement system configured to output optical measurement data representative of one or more optical measurements performed with respect to the user.

2. The system of claim 1, further comprising a processor configured to perform an operation based on the audio content and the optical measurement data.

3. The system of claim 2, wherein the processor is included in the hearing device.

4. The system of claim 2, wherein the processor is included in a device separate from the hearing device.

5. The system of claim 2, wherein the performing the operation comprises adjusting one or more attributes associated with the audio content based on the optical measurement data.

6. The system of claim 5, wherein the adjusting the one or more attributes of the audio content comprises wirelessly transmitting one or more commands to one or more of the hearing device or an audio player device communicatively coupled to the hearing device.

7. The system of claim 5, wherein the adjusting of the one or more attributes associated with the audio content comprises controlling an operation of the hearing device.

8. The system of claim 5, wherein the adjusting of the one or more attributes associated with the audio content comprises control ling an operation of an audio player device communicatively coupled to the hearing device, the audio player device configured to provide the audio content to the hearing device for presentation to the user.

9. The system of claim 5, wherein the adjusting of the one or more attributes associated with the audio content based on the optical measurement data comprises:
determining, based on the optical measurement data, an effect of the audio content on the user; and
adjusting the one or more attributes of the audio content based on the determined effect.

10. The system of claim 5, wherein the adjusting of the one or more attributes associated with the audio content based on the optical measurement data comprises:
determining, based on the optical measurement data, a current mental state of the user;
obtaining data representative of a desired mental state of the user; and
adjusting, based on the current mental state and the desired mental state, the one or more attributes of the audio content to change the current mental state of the user to the desired mental state of the user.

11. The system of claim 2, wherein the performing the operation comprises presenting, by way of a graphical user interface, content associated with the optical measurement data.

12. The system of claim 1, wherein:
the hearing device is implemented by a left headphone configured to be worn at a left ear of the user, a right headphone configured to be worn at a right ear of the user, and a headband configured to be worn on a head of the user and to connect the left headphone to the right headphone; and
the optical measurement system is included in one or more of the left headphone, the right headphone, or the headband.

13. The system of claim 1, wherein:
the hearing device further comprises an earpiece configured to be worn by the user at an entrance to an ear canal of the user; and
the optical measurement system is included in the earpiece.

14. The system of claim 1, wherein:
the hearing device further comprises a microphone configured to detect sound; and
the audio content is based on the sound.

15. The system of claim 1, wherein the one or more optical measurements comprise one or more brain activity measurements.

16. The system of claim 1, wherein the one or more optical measurements comprise one or more non-invasive measurements of blood oxygen saturation (SaO2) through Time-Resolved Pulse Oximetry (TR-SpO2).

17. The system of claim 1, wherein the optical measurement system comprises:
a plurality of light sources each configured to emit light directed at a brain of the user, and
a plurality of detectors configured to detect arrival times for photons of the light after the light is scattered by the brain, the optical measurement data based on the arrival times.

18. The system of claim 17, wherein the detectors each comprise a plurality of single-photon avalanche diode (SPAD) circuits.

19. The system of claim 17, wherein the optical measurement system further comprises a plurality of electrodes configured to detect electrical activity of the brain, the optical measurement data further based on the electrical activity.

20. A system comprising:
a hearing device configured to be worn by a user and present audio content to the user;
an optical measurement system included in the hearing device, the optical measurement system configured to perform one or more optical measurements with respect to the user and output optical measurement data representative of the one or more optical measurements; and
a processor configured to perform an operation based on the audio content and the optical measurement data.

21. The system of claim 20, wherein the processor is included in the hearing device.

22. The system of claim 20, wherein the processor is included in a device separate from the hearing device.

23. The system of claim 20, wherein the performing the operation comprises adjusting one or more attributes associated with the audio content based on the optical measurement data.

24. The system of claim 23, wherein the adjusting of the one or more attributes of the audio content comprises wirelessly transmitting one or more commands to one or more of the hearing device or an audio player device communicatively coupled to the hearing device.

25. The system of claim 23, wherein the adjusting of the one or more attributes associated with the audio content comprises controlling an operation of the hearing device.

26. The system of claim 23, wherein the adjusting of the one or more attributes associated with the audio content comprises controlling an operation of an audio player device communicatively coupled to the hearing device, the audio player device configured to provide the audio content to the hearing device for presentation to the user.

27. The system of claim 23; wherein the adjusting of the one or more attributes associated with the audio content based on the optical measurement data comprises:
determining, based on the optical measurement data, an effect of the audio content on the user; and
adjusting the one or more attributes of the audio content based on the determined effect.

28. The system of claim 23, wherein the adjusting of the one or more attributes associated with the audio content based on the optical measurement data comprises:
determining, based on the optical measurement data, a current mental state of the user;
obtaining data representative of a desired mental state of the user; and
adjusting, based on the current mental state and the desired mental state, the one or more attributes of the audio content to change the current mental state of the user to the desired mental state of the user.

29. The system of claim 20, wherein the performing the operation comprises presenting, by way of a graphical user interface, content associated with the optical measurement data.

30. The system of claim 20, wherein:
the hearing device is implemented by a left headphone configured to be worn at a left ear of the user, a right headphone configured to be worn at a right ear of the user, and a headband configured to be worn on a head of the user and to connect the left headphone to the right headphone; and
the optical measurement system is included in one or more of the left headphone, the right headphone, or the headband.

31. The system of claim 20, wherein:
the hearing device further comprises an earpiece configured to be worn by the user at an entrance to an ear canal of the user; and
the optical measurement system is included in the earpiece.

32. The system of claim 20, wherein the one or more optical measurements comprise one or more brain activity measurements.

33. The system of claim 20, wherein the one or more optical measurements comprise one or more non-invasive measurements of blood oxygen saturation (SaO2) through Time-Resolved Pulse Oximetry (TR-SpO2).

34. The system of claim 20, wherein the optical measurement system comprises:
a plurality of light sources each configured to emit light directed at a brain of the user, and
a plurality of detectors configured to detect arrival times for photons of the light after the it is scattered by the brain, the optical measurement data based on the arrival times.

35. The system of claim 34, wherein the detectors each comprise a plurality of single-photon avalanche diode (SPAD) circuits.

36. The system of claim 34, wherein the optical measurement system further comprises a plurality of electrodes configured to detect electrical activity of the brain, the optical measurement data further based on the electrical activity.

37-54. (canceled)
